(19) United States
(12) Patent Application Publication
(10) Pub. No.: US 2025/0392216 A1
(43) Pub. Date: Dec. 25, 2025

(54) CONTROLLER CIRCUIT, STEP-UP/STEP-DOWN DC/DC CONVERTER, AND VEHICLE EQUIPPED WITH THE SAME

(71) Applicant: ROHM CO., LTD., Kyoto (JP)

(72) Inventor: Takayuki KAMEI, Kyoto (JP)

(21) Appl. No.: 19/237,144

(22) Filed: Jun. 13, 2025

(30) Foreign Application Priority Data
Jun. 20, 2024 (JP) 2024-099636

(51) Int. Cl. H02M 3/157; H02M 1/088; H02M 3/158

(52) U.S. Cl. CPC H02M 3/157; H02M 1/088; H02M 3/158

(57) ABSTRACT

A controller circuit for a step-up/step-down DC/DC converter generating an output voltage according to an input voltage includes: step-down and step-up switch circuits respectively including high-side and low-side transistors and respectively receiving the input voltage and outputting the output voltage; ramp voltage and middle voltage generation circuits respectively generating a ramp voltage based on a first clock signal and a middle voltage of the ramp voltage; an error amplifier circuit generating an error signal from an error between a feedback voltage of the output voltage and a reference voltage; an inverting amplifier generating an inverted signal by inverting the error signal based on the middle voltage; first and second comparators generating first and second PWM signals by respectively comparing the ramp voltage with the error and inverted signals; and a logic circuit generating a control signal for the high-side and low-side transistors based on the first and second PWM signals.

### CROSS-REFERENCE TO RELATED APPLICATION

The present invention claims priority under 35 U.S.C. § 119 to Japanese Patent Application No. 2024-099636, filed on Jun. 20, 2024, the entire contents of which are incorporated herein by reference.

### TECHNICAL FIELD

The present disclosure relates to a controller circuit, a step-up/step-down DC/DC converter, and a vehicle equipped with the same.

### BACKGROUND

In the related art, a step-up/step-down DC/DC converter capable of both stepping-up and stepping-down is known.

### BRIEF DESCRIPTION OF DRAWINGS

The accompanying drawings, which are incorporated in and constitute a part of the specification, illustrate embodiments of the present disclosure.

FIG. 1 is a block diagram of a step-up/step-down DC/DC converter according to an embodiment of the present disclosure.

FIG. 2 is a timing chart showing an example of ramp voltages generated by a first ramp voltage generator and a second ramp voltage generator according to the embodiment.

FIG. 3 is a timing chart showing an example of an operation in a step-down mode of the step-up/step-down DC/DC converter according to the embodiment.

FIG. 4 is a timing chart showing an example of an operation in a step-up mode of the step-up/step-down DC/DC converter according to the embodiment.

FIG. 5 is a timing chart for explaining an example of an operation of a middle voltage generation circuit according to the embodiment.

FIG. 6 is a timing chart showing an example of a ramp voltage affected by an operation in the middle voltage generation circuit according to the embodiment.

FIG. 7 is a timing chart showing another example of the operation of the step-up/step-down DC/DC converter according to the embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### Overview

An overview of some exemplary embodiments of the present disclosure is described. This overview presents, in a simplified form, some concepts of one or more embodiments, as a prologue to the detailed description which is presented later, and for the purpose of basic understanding of the embodiments, but it is not intended to limit the scope of the disclosure. This overview is not a comprehensive overview of all conceivable embodiments, and it is intended to neither identify key elements of all embodiments nor delineate the scope of some or all aspects. For the sake of convenience, “an embodiment” may be used to refer to one embodiment (example or modification) or a plurality of embodiments (examples or modifications) disclosed herein.

A controller circuit according to one embodiment generates an output voltage according to an input voltage. The controller circuit includes: a step-down switch circuit that includes a high-side transistor and receives the input voltage; a step-up switch circuit that includes a low-side transistor and outputs the output voltage; a ramp voltage generation circuit that generates a ramp voltage based on a first clock signal; a middle voltage generation circuit that generates a middle voltage of the ramp voltage based on the ramp voltage generated by the ramp voltage generation circuit; an error amplifier circuit that generates an error signal based on an error between a feedback voltage of the output voltage and a reference voltage; an inverting amplifier that inverts the error signal based on the middle voltage generated by the middle voltage generation circuit to generate an inverted signal; a first comparator that compares the ramp voltage with the error signal to generate a first PWM signal; a second comparator that compares the ramp voltage with the inverted signal to generate a second PWM signal; and a logic circuit that generates a control signal for controlling operations of the high-side transistor and the low-side transistor based on the first PWM signal and the second PWM signal.

According to this configuration, the middle voltage generation circuit generates the middle voltage of the ramp voltage based on the ramp voltage generated by the ramp voltage generation circuit. As a result, even if a peak voltage of the ramp voltage for generating the PWM signal changes, the middle voltage of the ramp voltage may be generated following the change, and an appropriate operation of the step-up/step-down DC/DC converter may be realized.

In one embodiment, the ramp voltage generation circuit may include a first ramp voltage generator and a second ramp voltage generator that respectively generate ramp voltages. The second ramp voltage generator may be configured to generate the ramp voltage having a same form as the ramp voltage generated by the first ramp voltage generator in synchronization with the first ramp voltage generator. The middle voltage generation circuit may generate the middle voltage of the ramp voltage based on the ramp voltage generated by the first ramp voltage generator. The first comparator may compare the ramp voltage generated by the second ramp voltage generator with the error signal to generate the first PWM signal. The second comparator may compare the ramp voltage generated by the second ramp voltage generator with the inverted signal to generate the second PWM signal.

In one embodiment, the first ramp voltage generator and the second ramp voltage generator respectively may generate the ramp voltages that are commonly based on the first clock signal. The middle voltage generation circuit may include a phase adjustment circuit that generates a second clock signal by adjusting a phase of the first clock signal, and a sample/hold circuit that samples and holds the ramp voltage generated by the first ramp voltage generator. The phase adjustment circuit may generate the second clock signal by adjusting the phase of the first clock signal so that it is possible for the sample/hold circuit to sample and hold the middle voltage of the ramp voltage generated by the first ramp voltage generator based on the second clock signal.

In one embodiment, the sample/hold circuit may include a switch that operates according to the second clock signal, and a capacitor that samples and holds the ramp voltage generated by the first ramp voltage generator. The capacitor may be provided to sample the ramp voltage generated by the first ramp voltage generator when the switch is on, and to hold a sampled voltage when the switch is off.

In one embodiment, the ramp voltage generation circuit may change a peak voltage of the generated ramp voltage according to a change in a frequency of the clock signal that is input.

In one embodiment, the ramp voltage generation circuit may change the peak voltage of the ramp voltage according to a change in the input voltage.

In one embodiment, the controller circuit may be integrated on a single semiconductor chip.

A step-up/step-down DC/DC converter according to one embodiment may include the above-described controller circuit.

A vehicle according to one embodiment may include the above-described step-up/step-down DC/DC converter.

### EMBODIMENTS

Preferred embodiments are now described with reference to the drawings. Like or equivalent components, members, and processes illustrated in each drawing are given like reference numerals and a repeated description thereof are omitted as appropriate. Further, the embodiments are presented by way of examples only and are not intended to limit the present disclosure, and any features or combination thereof described in the embodiments may not necessarily be essential to the present disclosure.

In the present disclosure, “a state where a member A is connected to a member B” includes not only a case where the member A and the member B are physically directly connected, but also a case where the member A and the member B are indirectly connected through any other member that does not substantially affect an electrical connection state between the members A and B or does not impair functions and effects achieved by combinations of the members A and B.

Similarly, “a state where a member C is connected (installed) between a member A and a member B” includes not only a case where the member A and the member C or the member B and the member C are directly connected, but also a case where the member A and the member C or the member B and the member C are indirectly connected through any other member that does not substantially affect an electrical connection state between the members A and C or the members B and C or does not impair functions and effects achieved by combinations of the members A and C or the members B and C.

Further, in the present disclosure, symbols attached to electrical signals such as voltage signals and current signals, or symbols attached to circuit elements such as resistors, capacitors, and inductors, represent respective voltage values, current values, or circuit constants (resistance, capacitance, and inductance) as necessary.

Further, in the present disclosure, “integrated” includes a case where all of components of a circuit are formed on a semiconductor substrate or a case where main components of a circuit are integrated, and some resistors, capacitors, etc. may be provided outside the semiconductor substrate for adjusting circuit constants.

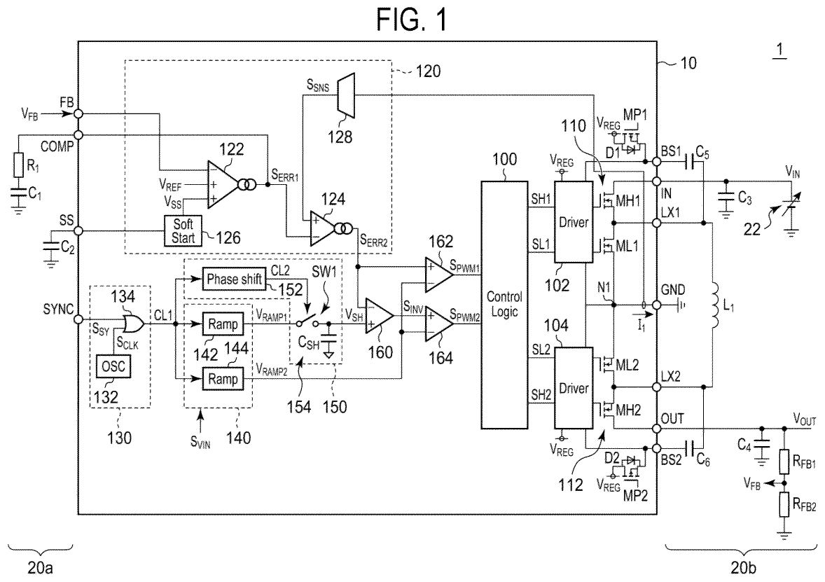

FIG. 1 is a block diagram of a step-up/step-down DC/DC converter 1 according to an embodiment of the present disclosure. The step-up/step-down DC/DC converter 1 generates an output voltage V_{OUT} according to an input voltage V_{IN}. The step-up/step-down DC/DC converter 1 may be mounted on a vehicle, for example. The step-up/step-down DC/DC converter 1 according to the embodiment includes a semiconductor circuit 10 and peripheral circuits 20a and 20b.

The semiconductor circuit 10 is a controller circuit that controls an operation of the step-up/step-down DC/DC converter 1. The semiconductor circuit 10 according to the embodiment mainly includes a logic circuit 100, a step-down driver 102, a step-up driver 104, a step-down switch circuit 110, a step-up switch circuit 112, an error amplifier circuit 120, a clock signal generation circuit 130, a ramp voltage generation circuit 140, a middle voltage generation circuit 150, an inverting amplifier 160, a first comparator 162, a second comparator 164, transistors MP1 and MP2, and diodes D1 and D2. The semiconductor circuit 10 may be integrated on a single semiconductor substrate.

The semiconductor circuit 10 according to the embodiment further includes various pins to be connected to circuit elements of the peripheral circuits 20a and 20b and the like, and specifically includes a feedback pin FB, pins COMP, SYNC, and SS, an input pin IN, an output pin OUT, a ground pin GND, switching pins LX1 and LX2, and bootstrap pins BS1 and BS2.

The step-down switch circuit 110 receives the input voltage VIN via the input pin IN. The step-down switch circuit 110 includes a first high-side transistor MH1 and a first low-side transistor ML1. The first high-side transistor MH1 and the first low-side transistor ML1 are each composed of an N-channel MOS (Metal Oxide Semiconductor) transistor. Also, the first low-side transistor ML1 may be replaced with another switch element such as a diode. A drain of the first high-side transistor MH1 is connected to the input pin IN. A source of the first low-side transistor ML1 is connected to the ground pin GND. The switching pin LX1 is connected between the first high-side transistor MH1 and the first low-side transistor ML1.

The step-up switch circuit 112 outputs the output voltage V_{OUT} via the output pin OUT. The step-up switch circuit 112 includes a second high-side transistor MH2 and a second low-side transistor ML2. The second high-side transistor MH2 and the second low-side transistor ML2 are each composed of an N-channel MOS transistor. Also, the second high-side transistor MH2 may be replaced with another switch element such as a diode. A drain of the second high-side transistor MH2 is connected to the output pin OUT. A source of the second low-side transistor ML2 is connected to the ground pin GND. The switching pin LX2 is connected between the second high-side transistor MH2 and the second low-side transistor ML2.

The logic circuit 100 generates control signals SH1, SL1, SH2, and SL2 for controlling operations of the transistors in the step-down switch circuit 110 and the transistors in the step-up switch circuit 112 based on a first PWM signal S_{PWM1} and a second PWM signal S_{PWM2}. The control signals SH1, SL1, SH2, and SL2 are signals for controlling the operations of the first high-side transistor MH1, the first low-side transistor ML1, the second high-side transistor MH2, and the second low-side transistor ML2, respectively.

The logic circuit 100 may generate the control signals SH1, SL1, SH2, and SL2 such that the step-down switch circuit 110 and the step-up switch circuit 112 operate in conjunction with each other, specifically, such that when the step-down switch circuit 110 operates at a certain duty ratio, the step-up switch circuit 112 operates at a duty ratio corresponding to the certain duty ratio. More specifically, the logic circuit 100 generates the control signals SH1 and SL2 such that the first high-side transistor MH1 and the second low-side transistor ML2 operate complementarily, that is, such that when one transistor is at a high level, the other transistor is at a low level.

The logic circuit 100 according to the embodiment generates the control signal SH1 by taking XNOR of the first PWM signal S_{PWM1} and the second PWM signal _{SPWM2}. In addition, the logic circuit 100 generates the control signal SL2 by taking XOR of the first PWM signal S_{PWM1} and the second PWM signal S_{PWM2}. This generates the control signal SL2 which is an inversion of the control signal SH1.

The step-down driver 102 and the step-up driver 104 each operate by receiving an internal power supply voltage V_{REG}. The step-down driver 102 drives the first high-side transistor MH1 and the first low-side transistor ML1 of the step-down switch circuit 110 based on the control signals SH1 and SL1. The step-up driver 104 drives the second high-side transistor MH2 and the second low-side transistor ML2 of the step-up switch circuit 112 based on the control signals SH2 and SL2.

The transistors MP1 and MP2 are each composed of a P-channel MOS transistor. An internal power supply voltage V_{REG} is supplied to each of drains of the transistors MP1 and MP2. A source of the transistor MP1 is connected to the bootstrap pin BS1, and a source of the transistor MP2 is connected to the bootstrap pin BS2. The internal power supply voltage V_{REG} is supplied to each of anodes of the diodes D1 and D2. A cathode of the diode D1 is connected to the bootstrap pin BS1, and a cathode of the diode D2 is connected to the bootstrap pin BS2.

The error amplifier circuit 120 generates an error signal S_{ERR2} based on an error between a feedback voltage V_{FB} of the output voltage V_{OUT} and a reference voltage V_{REF}. The error amplifier circuit 120 according to the embodiment is configured to feed back the output voltage V_{OUT} and a current I₁ flowing between the node N1 and the ground pin GND. The error amplifier circuit 120 includes a first error amplifier 122, a second error amplifier 124, a soft start circuit 126, and a current detection circuit 128.

The soft start circuit 126 is connected to the pin SS. The soft start circuit 126 generates a soft start voltage V_{SS}. The soft start voltage V_{SS} is input to the first error amplifier 122.

The first error amplifier 122 generates an error signal S_{ERR1} by amplifying the error between the feedback voltage V_{FB} and the reference voltage V_{REF}. The error signal S_{ERR1} is input to an inverting input terminal of the second error amplifier 124. The feedback voltage V_{FB} is input to an inverting input terminal of the first error amplifier 122 via the feedback pin FB. The reference voltage V_{REF} is input to a non-inverting input terminal of the first error amplifier 122. An output terminal of the first error amplifier 122 is connected to the pin COMP.

The current detection circuit 128 detects the current I₁ flowing between the node N1 and the ground pin GND and generates a detection signal S_{SNS} according to the detection result. The detection signal S_{SNS} is input to a non-inverting input terminal of the second error amplifier 124.

The second error amplifier 124 generates the error signal S_{ERR2} by amplifying an error between the error signal S_{ERR1} and the detection signal S_{SNS}. The error signal S_{ERR2} is input to an inverting input terminal of the inverting amplifier 160 and a non-inverting input terminal of the first comparator 162.

The clock signal generation circuit 130 generates a clock signal CL1. The clock signal generation circuit 130 includes an oscillator 132 and an OR circuit 134. The oscillator 132 generates a clock signal S_{CLK}. The OR circuit 134 generates the clock signal CL1 based on a signal S_{SY}, which is input via the pin SYNC, and the clock signal S_{CLK}. The clock signal CL1 is input to the ramp voltage generation circuit 140 and the middle voltage generation circuit 150. When the signal S_{SY} is at a high level, the clock signal CL1 becomes the clock signal S_{CLK}, and when the signal S_{SY} is at a low level, the clock signal CLI becomes a low level.

The ramp voltage generation circuit 140 generates ramp voltages V_{RAMP1} and V_{RAMP2} based on the clock signal CL1. Hereinafter, when there is no particular distinction between the ramp voltages V_{RAMP1} and V_{RAMP2}, they are collectively referred to simply as a “ramp voltage V_{RAMP}.” The ramp voltage V_{RAMP} may be, for example, a periodic sawtooth wave or triangular wave. The ramp voltage generation circuit 140 according to the embodiment includes a first ramp voltage generator 142 and a second ramp voltage generator 144.

The first ramp voltage generator 142 generates the ramp voltage V_{RAMP1} based on the clock signal CL1. The second ramp voltage generator 144 is configured to generate the ramp voltage V_{RAMP2}, which has the same form as the ramp voltage V_{RAMP1} generated by the first ramp voltage generator 142, in synchronization with the first ramp voltage generator 142. The second ramp voltage generator 144 is synchronized with the first ramp voltage generator 142 by receiving the clock signal CL1 common to the first ramp voltage generator 142. The ramp voltage V_{RAMP2} is input to an inverting input terminal of each of the first comparator 162 and the second comparator 164.

The ramp voltage generation circuit 140 according to the embodiment is configured such that a peak voltage of the generated ramp voltage V_{RAMP} changes according to a change in a frequency of the input clock signal CL1. The peak voltage is a maximum voltage during one period of the ramp voltage V_{RAMP}. In the embodiment, the first ramp voltage generator 142 changes a peak voltage of the ramp voltage V_{RAMP1} according to the change in the frequency of the clock signal CL1, and the second ramp voltage generator 144 changes a peak voltage of the ramp voltage V_{RAMP2} according to the change in the frequency of the clock signal CL1. Specifically, the peak voltage of the ramp voltage V_{RAMP} may become smaller as the frequency of the clock signal CL1 increases.

The ramp voltage generation circuit 140 according to the embodiment is configured such that the peak voltage of the ramp voltage V_{RAMP} changes according to a change in the input voltage V_{IN}. For example, the ramp voltage generation circuit 140 may change the peak voltage of the ramp voltage V_{RAMP} based on a signal S_{VIN} corresponding to the input voltage V_{IN}. In the embodiment, the first ramp voltage generator 142 changes the peak voltage of the ramp voltage V_{RAMP1} in response to the change in the input voltage V_{IN}, and the second ramp voltage generator 144 changes the peak voltage of the ramp voltage V_{RAMP2} in response to the change in the input voltage V_{IN}. For example, the peak voltage of the ramp voltage V_{RAMP} may become larger as the input voltage V_{IN} increases.

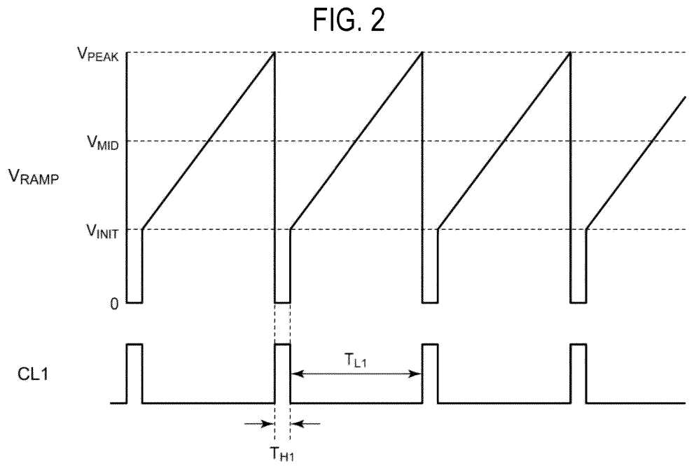

FIG. 2 is a timing chart showing an example of the ramp voltage V_{RAMP} generated by the first ramp voltage generator 142 and the second ramp voltage generator 144 according to the embodiment. As shown in FIG. 2, the ramp voltage V_{RAMP} according to the embodiment is a periodic sawtooth wave. The ramp voltage V_{RAMP} is 0 V during a period when the clock signal CL1 having a predetermined frequency is at a high level (hereinafter also referred to as a “high level period T_{H1}”). In addition, the ramp voltage V_{RAMP} rises linearly from an initial voltage V_{INIT} (>0) to a peak voltage V_{PEAK} during a period T_{L1} when the clock signal CL1 is at a low level (hereinafter also referred to as a “low level period T_{L1}”).

When the frequency of the clock signal CL1 changes, the low level period T_{L1} changes. If it is assumed that the initial voltage V_{INIT} and a slope of the ramp voltage V_{RAMP} in the low level period T_{L1} do not change in each period, the longer the low level period T_{L1}, the larger the peak voltage V_{PEAK} is. Therefore, a middle voltage V_{MID} of the ramp voltage V_{RAMP} (i.e., a voltage in the middle between the initial voltage V_{INIT} and the peak voltage V_{PEAK}) becomes larger as the low level period T_{L1} becomes longer. In this way, the middle voltage V_{MID} of the ramp voltage V_{RAMP} may change according to the change in the frequency of the clock signal CL1.

In the embodiment, the slope of the ramp voltage V_{RAMP} in the low level period T_{L1} may change according to the change in the input voltage V_{IN}. For example, if the slope of the ramp voltage V_{RAMP} in the low level period T_{L1} becomes larger as the input voltage V_{IN} increases, the peak voltage V_{PEAK} increases as the input voltage V_{IN} increases. As a result, the middle voltage V_{MID} also increases. In this way, the middle voltage V_{MID} of the ramp voltage V_{RAMP} may change according to the change in the input voltage V_{IN}.

Returning to FIG. 1, the middle voltage generation circuit 150 is described. The middle voltage generation circuit 150 generates the middle voltage of the ramp voltage V_{RAMP} based on the ramp voltage V_{RAMP} generated by the ramp voltage generation circuit 140. In the embodiment, the middle voltage generation circuit 150 generates a middle voltage of the ramp voltage V_{RAMP1} based on the ramp voltage V_{RAMP1} generated by the first ramp voltage generator 142.

The middle voltage generation circuit 150 according to the embodiment includes a phase adjustment circuit 152 and a sample/hold circuit 154 that samples and holds the ramp voltage V_{RAMP1} generated by the first ramp voltage generator 142.

The phase adjustment circuit 152 adjusts a phase of the clock signal CL1 to generate a clock signal CL2 with the adjusted phase. Specifically, the phase adjustment circuit 152 may adjust a timing of a rising edge of the clock signal CL1. More specifically, the phase adjustment circuit 152 may generate a clock signal CL3 with the same rising edge timing as the clock signal CL1 and with a pulse width adjusted from the clock signal CL1. The phase adjustment circuit 152 may generate the clock signal CL2 that rises at a timing of a falling edge of the clock signal CL3. As a result, the clock signal CL2 delayed in phase by the pulse width of the clock signal CL3 is generated.

The phase adjustment circuit 152 generates the clock signal CL2 with the adjusted phase of the clock signal CL1 so that it is possible for the sample/hold circuit 154 to sample and hold the middle voltage of the ramp voltage V_{RAMP1} based on the clock signal CL2. In the embodiment, the phase adjustment circuit 152 generates the clock signal CL2 by delaying the phase of the clock signal CL1 by 180°. In the embodiment, since the waveform of the ramp voltage V_{RAMP1} is a sawtooth wave, it is possible to sample the middle voltage of the ramp voltage V_{RAMP1} by sampling the ramp voltage V_{RAMP1} at a timing delayed in phase by 180° from the timing of the rising edge of the clock signal CL1.

Further, a magnitude of the phase adjusted by the phase adjustment circuit 152 may be changed according to the waveform of the ramp voltage V_{RAMP1}. For example, if the ramp voltage V_{RAMP1} is a triangular wave, the phase adjustment circuit 152 may delay the phase of the clock signal CL1 by 90° to generate the clock signal CL2. Even in this case, it is possible for the sample/hold circuit 154 to sample and hold the middle voltage of the ramp voltage V_{RAMP1} based on the clock signal CL2.

The sample/hold circuit 154 according to the embodiment is configured to sample the ramp voltage V_{RAMP1} when the clock signal CL2 is at a high level, and to hold a voltage obtained by the sampling (hereinafter also referred to as a “hold voltage V_{SH}”) when the clock signal CL2 is at a low level. The sample/hold circuit 154 includes a switch SW1 that operates according to the clock signal CL2 with the phase adjusted by the phase adjustment circuit 152, and a capacitor C_{SH} that samples and holds the ramp voltage V_{RAMP1} generated by the first ramp voltage generator 142.

The switch SW1 is provided between an output terminal of the first ramp voltage generator 142 and a non-inverting input terminal of the inverting amplifier 160. The switch SW1 operates according to the clock signal CL2. Specifically, the switch SW1 is on when the clock signal CL2 is at a high level, and is off when the clock signal CL2 is at a low level.

The capacitor C_{SH} is provided to sample the ramp voltage V_{RAMP1} generated by the first ramp voltage generator 142 when the switch SW1 is on, and to hold the sampled voltage when the switch SW1 is off. Specifically, one end of the capacitor C_{SH} is connected between the switch SW1 and the non-inverting input terminal of the inverting amplifier 160, and the other end of the capacitor C_{SH} is connected to the ground.

When the switch SW1 is on, the ramp voltage V_{RAMP1} is supplied to the capacitor C_{SH} via the switch SW1, and the capacitor C_{SH} samples the ramp voltage V_{RAMP1}. Since the middle voltage of the ramp voltage V_{RAMP1} is supplied to the capacitor C_{SH} when the switch SW1 is on, the capacitor C_{SH} may sample the middle voltage of the ramp voltage V_{RAMP1}. The capacitor C_{SH} holds the sampled voltage, and the hold voltage V_{SH} is input to the non-inverting input terminal of the inverting amplifier 160.

The inverting amplifier 160 inverts the error signal S_{ERR2} based on the middle voltage (hold voltage V_{SH}) generated by the middle voltage generation circuit 150 to generate an inverted signal S_{INV}. Specifically, when S_{ERR2}<V_{SH}, the inverting amplifier 160 generates the inverted signal S_{INV} such that S_{INV}−V_{SH}=V_{SH}−S_{ERR2} (S_{INV}>V_{SH}). In addition, when S_{ERR2}>V_{SH}, the inverting amplifier 160 generates the inverted signal S_{INV} such that V_{SH}−S_{INV}=S_{ERR2}−V_{SH} (S_{INV}<V_{SH}). Further, when S_{ERR2}=V_{SH}, the inverting amplifier 160 generates the inverted signal S_{INV} such that S_{INV}=S_{ERR2}. The inverted signal S_{INV} is input to a non-inverting input terminal of the second comparator 164.

The first comparator 162 compares the ramp voltage V_{RAMP} with the error signal S_{ERR2} to generate the first PWM signal S_{PWM1}. The first comparator 162 according to the embodiment compares the ramp voltage V_{RAMP2} generated by the second ramp voltage generator 144 with the error signal S_{ERR2} to generate the first PWM signal S_{PWM1}. The first PWM signal S_{PWM1} has a high level when S_{ERR2}>V_{RAMP2}, and has a low level when S_{ERR2}<V_{RAMP2}.

The second comparator 164 compares the ramp voltage V_{RAMP} with the inverted signal S_{INV} to generate the second PWM signal S_{PWM2}. The second comparator 164 according to the embodiment compares the ramp voltage V_{RAMP2} generated by the second ramp voltage generator 144 with the inverted signal S_{INV} to generate the second PWM signal S_{PWM2}. The second PWM signal S_{PWM2} has a high level when S_{INV}>V_{RAMP2}, and has a low level when S_{INV}<V_{RAMP2}.

The peripheral circuit 20a includes a resistor R₁ and capacitors C₁ and C₂. The resistor R₁ and the capacitor C₁ are connected in series. One end of the capacitor C₁ on the opposite side of the resistor R₁ is grounded, and one end of the resistor R₁ on the opposite side of the capacitor C₁ is connected to the pin COMP. One end of the capacitor C₂ is grounded, and the other end of the capacitor C₂ is connected to the pin SS.

The peripheral circuit 20b includes a variable voltage source 22, resistors R_{FB1} and R_{FB2}, capacitors C₃ to C₆, and an inductor L₁.

The variable voltage source 22 supplies the input voltage V_{IN} to the input pin IN. One end of the capacitor C₃ is connected to the input pin IN, and the other end of the capacitor C₃ is grounded. One end of the capacitor C₄ is connected to the output pin OUT, and the other end of the capacitor C₄ is grounded. The resistors R_{FB1} and R_{FB2} are connected in series and divide the output voltage V_{OUT} to generate the feedback voltage V_{FB}. Here, V_{FB}=V_{OUT}×R_{FB2}/(R_{FB1} +R_{FB2}).

One end of the inductor L₁ is connected to the switching pin LX1, and the other end of the inductor L₁ is connected to the switching pin LX2. One end of the capacitor C₅ is connected to the bootstrap pin BS1, and the other end of the capacitor C₅ is connected to the one end of the inductor L₁. One end of the capacitor C₆ is connected to the bootstrap pin BS2, and the other end of the capacitor C₆ is connected to the other end of the inductor L₁.

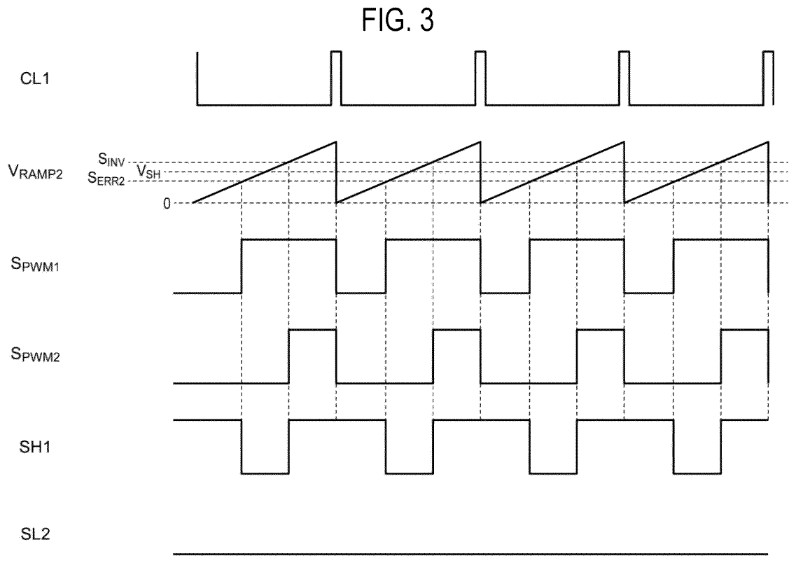

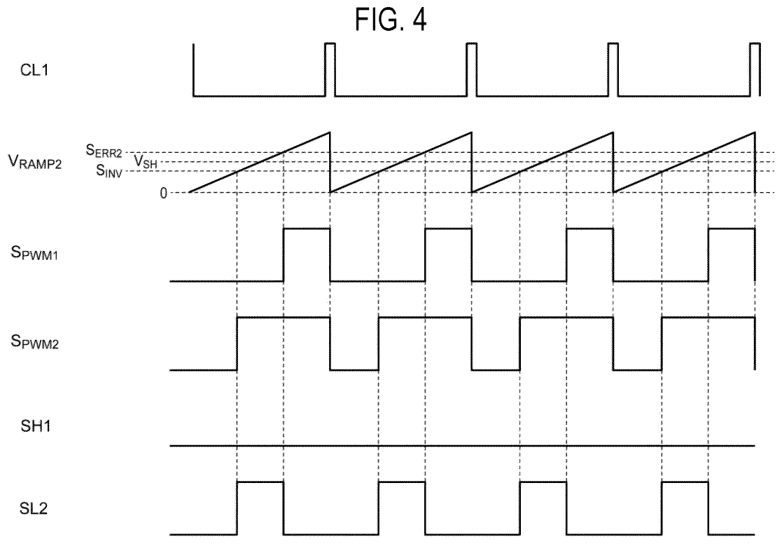

FIG. 3 is a timing chart showing an example of an operation in a step-down mode of the step-up/step-down DC/DC converter 1 according to the embodiment. The hold voltage V_{SH} shown in FIG. 3 is assumed to be equal to the middle voltage V_{MID} of the ramp voltage V_{RAMP2} (V_{SH}=V_{MID}). The same applies to FIG. 4. The mode may be determined by a magnitude relationship between the error signal S_{ERR2} and the hold voltage V_{SH}. As shown in FIG. 3, in the step-down mode, the error signal S_{ERR2} is smaller than the hold voltage VSH (S_{ERR2}<V_{SH}).

The first PWM signal S_{PWM1} is generated according to a magnitude relationship between the error signal S_{ERR2} and the ramp voltage V_{RAMP2}, and the second PWM signal S_{PWM2} is generated according to a magnitude relationship between the inverted signal S_{INV} and the ramp voltage V_{RAMP2}. The first high-side transistor MH1 is driven according to the control signal SH1 generated by the XNOR of the first PWM signal S_{PWM1} and the second PWM signal S_{PWM2}. This generates the output voltage V_{OUT} by stepping down the input voltage V_{IN}. In addition, in the step-down mode, the control signal SL2 for controlling the operation of the second low-side transistor ML2 is at a low level, and the second low-side transistor ML2 is turned off.

FIG. 4 is a timing chart showing an example of an operation in a step-up mode of the step-up/step-down DC/DC converter 1 according to the embodiment. As shown in FIG. 4, in the step-up mode, the error signal S_{ERR2} is greater than the hold voltage V_{SH} (S_{ERR2}>V_{SH}). The second low-side transistor ML2 is driven according to the control signal SL2 generated by the XOR of the first PWM signal S_{PWM1} and the second PWM signal S_{PWM2}. This generates the output voltage V_{OUT} by stepping up the input voltage V_{IN}. In addition, in the step-up mode, the control signal SH1 for controlling the operation of the first high-side transistor MH1 is at a low level, and the first high-side transistor MH1 is turned off. Further, although FIGS. 3 and 4 show an example in which one of the first high-side transistor MH1 and the second low-side transistor ML2 is switched, both may be operated.

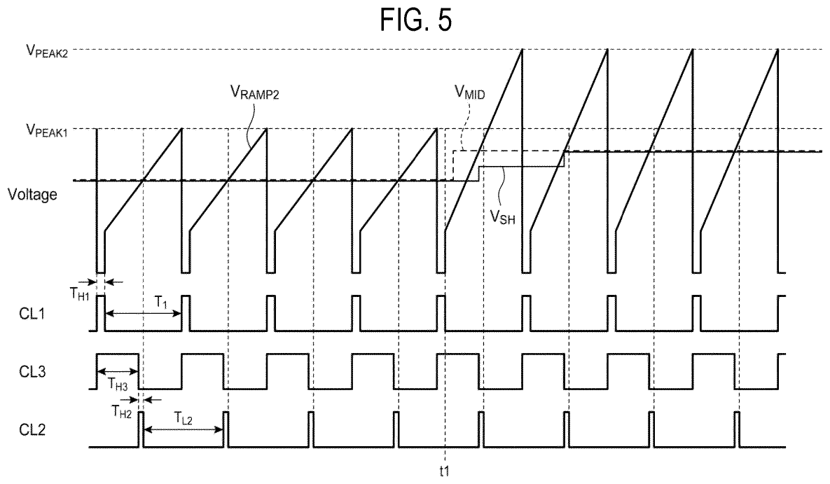

FIG. 5 is a timing chart for explaining an example of an operation of the middle voltage generation circuit 150 according to the embodiment. The phase adjustment circuit 152 generates the clock signal CL3 with the high level period T_{H1} (pulse width) of the clock signal CL1 adjusted to a half period of the clock signal CL1. Therefore, if the period of the clock signal CL1 is T₁, a high level period T_{H3} of the clock signal CL3 is T₁/2.

The phase adjustment circuit 152 generates the clock signal CL2 that rises at the timing of the falling edge of the clock signal CL3. This generates the clock signal CL2 that rises with a delay of half a period (T₁/2) compared to the clock signal CL1. In other words, the clock signal CL2 with a phase delay of 180° compared to the clock signal CL1 is generated. Here, a pulse width of the clock signal CL2 may be smaller than the pulse width of the clock signal CL1.

The sample/hold circuit 154 samples and holds the ramp voltage V_{RAMP1} based on the clock signal CL2. The sample/hold circuit 154 samples the ramp voltage V_{RAMP1} in a high level period T_{H2} of the clock signal CL2, and holds the sampled voltage in a low level period T_{L2} of the clock signal CL2.

In the example shown in FIG. 5, it is assumed that the slope of the ramp voltage V_{RAMP1} changes before and after timing t1, and the peak voltage of the ramp voltage V_{RAMP1} changes. Before timing t1, the peak voltage of the ramp voltage V_{RAMP1} is V_{PEAK1}, and after timing t1, the peak voltage of the ramp voltage V_{RAMP1} is V_{PEAK2}.

In FIG. 5, the true middle voltage V_{MID} is shown by a broken line, and the hold voltage VSH is shown by a solid line. As shown in FIG. 5, the true middle voltage V_{MID} is sampled by sampling the ramp voltage V_{RAMP1} at about two or three pulses of the clock signal after timing t1. Thus, according to the embodiment, even if the peak voltage of the ramp voltage V_{RAMP1} changes, it is possible to follow the change and obtain the middle voltage. In particular, if the middle voltage is obtained by following the change faster than a band of the first error amplifier 122 and the second error amplifier 124, it is possible to substantially eliminate influence of the fluctuation of the peak voltage of the ramp voltage V_{RAMP1} on the PWM control.

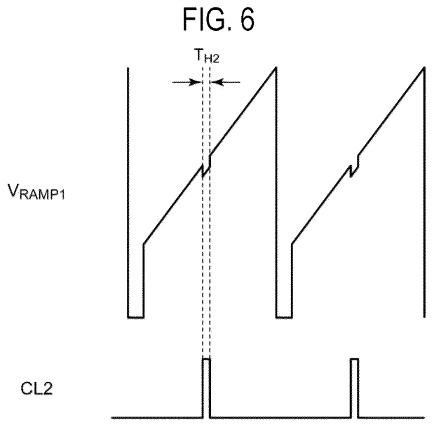

FIG. 6 is a timing chart showing an example of the ramp voltage V_{RAMP1} that is affected by the operation of the middle voltage generation circuit 150 according to the embodiment. As shown in FIG. 6, the ramp voltage V_{RAMP1} fluctuates due to influence of the sampling in the high level period T_{H2} of the clock signal CL2, during which sampling is performed by the sample/hold circuit 154. For this reason, if the ramp voltage V_{RAMP1} is input to the first comparator 162 and the second comparator 164, jitter occurs in the first PWM signal S_{PWM1} and the second PWM signal S_{PWM2}, making the PWM control unstable.

In the semiconductor circuit 10 according to the embodiment, rather than the ramp voltage V_{RAMP1} which is affected by the sampling, the ramp voltage V_{RAMP2} generated by the second ramp voltage generator 144 is input to the first comparator 162 and the second comparator 164. For this reason, jitter is suppressed from occurring in the first PWM signal S_{PWM1} and the second PWM signal S_{PWM2}, making it possible to stabilize the PWM control.

The configurations and operations of the step-up/step-down DC/DC converter 1 and its semiconductor circuit 10 according to the embodiment have been described above. With the semiconductor circuit 10 according to the embodiment, the middle voltage generation circuit 150 generates the middle voltage of the ramp voltage V_{RAMP1} based on the ramp voltage V_{RAMP1} generated by the ramp voltage generation circuit 140. As a result, even if the peak voltage of the ramp voltage V_{RAMP} for generating the PWM signals (the first PWM signal S_{PWM1} and second PWM signal S_{PWM2}) changes, it is possible to generate the middle voltage of the ramp voltage V_{RAMP} by following the change, and appropriately operate the step-up/step-down DC/DC converter 1.

### Another Operation Example

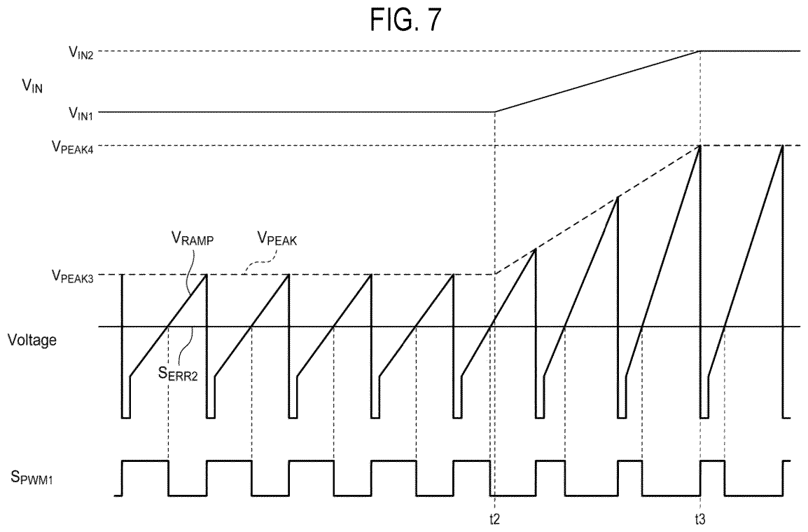

FIG. 7 is a timing chart showing another operation example of the step-up/step-down DC/DC converter 1 according to the above-described embodiment. In this operation example, the input voltage V_{IN} is V_{IN1} before timing t2, increases linearly from timing t2 to t3, and is maintained at V_{IN2} (>V_{IN1}) after timing t3.

In the example shown in FIG. 7, the slope of the ramp voltage V_{RAMP} changes according to a magnitude of the input voltage V_{IN}. Specifically, the slope of the ramp voltage V_{RAMP} gradually increases from timing t2 to t3 and becomes constant after timing t3. According to this change in slope, the peak voltage of the ramp voltage V_{RAMP} changes from V_{PEAK3} to V_{PEAK4} (>V_{PEAK3}).

When feedforward control is performed in the step-up/step-down DC/DC converter 1, the peak voltage V_{PEAK} of the ramp voltage V_{RAMP} may be linked to the input voltage V_{IN} in this manner. This allows duty control to be performed faster than responses of the first error amplifier 122 and the second error amplifier 124, thereby suppressing fluctuation in the output voltage V_{OUT} due to fluctuation in the input voltage V_{IN}. For example, when the input voltage V_{IN} increases as shown in FIG. 7, a duty ratio of the first PWM signal S_{PWM1} may be reduced accordingly.

Even in such a case, it is possible for the middle voltage generation circuit 150 to generate the middle voltage of the ramp voltage V_{RAMP} by following the change in the peak voltage of the ramp voltage V_{RAMP}. Therefore, it is possible to more reliably realize the appropriate operation of the step-up/step-down DC/DC converter 1 by feedforward control.

### Application Examples

In the above-described embodiment, an example in which the clock signal CK1 is generated inside the semiconductor circuit 10 has been described, but a clock signal may be generated externally and used. In this case, the first ramp voltage generator 142 and the second ramp voltage generator 144 may each generate a ramp voltage based on the clock signal input from the outside. Further, the middle voltage generation circuit 150 may generate a middle voltage of the ramp voltage based on the clock signal input from the outside and the ramp voltage generated by the first ramp voltage generator 142. Therefore, even if the semiconductor circuit does not have information on the clock signal input from the outside, it is possible to appropriately generate the middle voltage of the ramp voltage. This allows the step-up/step-down DC/DC converter to operate properly even when the clock signal is input from the outside.

Sometimes, an external synchronization function of inputting a clock signal from the outside and performing switching in synchronization with the clock signal is required for an in-vehicle step-up/step-down DC/DC converter. By applying the step-up/step-down DC/DC converter 1 according to the above-described embodiment, it is possible to meet such a requirement.

In addition, in the above-described embodiment, mainly, an example in which the frequency of the clock signal CL1 input to the ramp voltage generation circuit 140 and the middle voltage generation circuit 150 is constant has been described. However, without being limited thereto, the frequency of the clock signal CL1 may be changed as necessary. For example, the frequency of the clock signal CL1 may be changed to achieve a function of a spread spectrum clock generator (SSCG) that suppresses noise concentration to a specific frequency.

In the case of an in-vehicle step-up/step-down DC/DC converter, it is undesirable for the frequency of the clock signal to overlap with an AM (Amplitude Modulation) band of radio. It is desirable to periodically vary the frequency by the SSCG function so that the frequency of the clock signal is not fixed to a specific frequency in the AM band. In this case, the middle voltage of the ramp voltage also changes according to the change in the frequency, but the middle voltage generation circuit 150 can generate the middle voltage by following this change. This makes it possible to achieve both the SSCG function and the proper operation of the step-up/step-down DC/DC converter.

If it is possible for the semiconductor circuit 10 to generate the clock signal CL1 with a highly accurate frequency, it is possible to ensure that the frequency of the clock signal CL1 does not overlap with the AM band. However, if the accuracy of the frequency of the clock signal CL1 is low, the frequency varies. With the semiconductor circuit 10 according to the embodiment, the middle voltage generation circuit 150 generates the middle voltage based on the actually generated ramp voltage V_{RAMP}, and thus it is possible for the step-up/step-down DC/DC converter 1 to operate properly even if the frequency of the clock signal CL1 varies.

### Supplement

The embodiment according to the present disclosure has been described using specific terms, but this description is merely an example to aid understanding and does not limit the scope of the present disclosure or the claims, and the scope of the present disclosure is defined by the claims. In addition to the embodiment, embodiments, examples, and modifications not described herein are also included in the scope of the present disclosure.

### SUPPLEMENTARY NOTES

The technique disclosed in the present disclosure can be grasped in one aspect as follows.

### Supplementary Note 1

A controller circuit for a step-up/step-down DC/DC converter that generates an output voltage according to an input voltage, including:
a step-down switch circuit that includes a high-side transistor and receives the input voltage;
a step-up switch circuit that includes a low-side transistor and outputs the output voltage; a ramp voltage generation circuit that generates a ramp voltage based on a first clock signal;
a middle voltage generation circuit that generates a middle voltage of the ramp voltage based on the ramp voltage generated by the ramp voltage generation circuit;
an error amplifier circuit that generates an error signal based on an error between a feedback voltage of the output voltage and a reference voltage;
an inverting amplifier that inverts the error signal based on the middle voltage generated by the middle voltage generation circuit to generate an inverted signal;
a first comparator that compares the ramp voltage with the error signal to generate a first PWM signal;
a second comparator that compares the ramp voltage with the inverted signal to generate a second PWM signal; and
a logic circuit that generates a control signal for controlling operations of the high-side transistor and the low-side transistor based on the first PWM signal and the second PWM signal.

### Supplementary Note 2

The controller circuit of Supplementary Note 1, wherein the ramp voltage generation circuit includes a first ramp voltage generator and a second ramp voltage generator that respectively generate ramp voltages,
wherein the second ramp voltage generator is configured to generate the ramp voltage having a same form as the ramp voltage generated by the first ramp voltage generator in synchronization with the first ramp voltage generator, and the middle voltage generation circuit generates the middle voltage of the ramp voltage based on the ramp voltage generated by the first ramp voltage generator,
wherein the first comparator compares the ramp voltage generated by the second ramp voltage generator with the error signal to generate the first PWM signal, and
wherein the second comparator compares the ramp voltage generated by the second ramp voltage generator with the inverted signal to generate the second PWM signal.

### Supplementary Note 3

The controller circuit of Supplementary Note 2, wherein the first ramp voltage generator and the second ramp voltage generator respectively generate the ramp voltages that are commonly based on the first clock signal,
wherein the middle voltage generation circuit includes a phase adjustment circuit that generates a second clock signal by adjusting a phase of the first clock signal, and a sample/hold circuit that samples and holds the ramp voltage generated by the first ramp voltage generator, and
wherein the phase adjustment circuit generates the second clock signal by adjusting the phase of the first clock signal so that the sample/hold circuit samples and holds the middle voltage of the ramp voltage generated by the first ramp voltage generator based on the second clock signal.

### Supplementary Note 4

The controller circuit of Supplementary Note 3, wherein the sample/hold circuit includes a switch that operates according to the second clock signal, and a capacitor that samples and holds the ramp voltage generated by the first ramp voltage generator, and
wherein the capacitor is provided to sample the ramp voltage generated by the first ramp voltage generator when the switch is on, and to hold a sampled voltage when the switch is off.

### Supplementary Note 5

The controller circuit of any one of Supplementary Notes 1 to 4, wherein the ramp voltage generation circuit changes a peak voltage of the generated ramp voltage according to a change in a frequency of the first clock signal that is input.

### Supplementary Note 6

The controller circuit of any one of Supplementary Notes 1 to 5, wherein the ramp voltage generation circuit changes a peak voltage of the ramp voltage according to a change in the input voltage.

### Supplementary Note 7

The controller circuit of any one of Supplementary Notes 1 to 6, which is integrated on a single semiconductor chip.

### Supplementary Note 8

A step-up/step-down DC/DC converter, including:
the controller circuit of any one of Supplementary Notes 1 to 7.

### Supplementary Note 9

A vehicle, including:
the step-up/step-down DC/DC converter of Supplementary Note 8.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A controller circuit for a step-up/step-down DC/DC converter that generates an output voltage according to an input voltage, comprising:
a step-down switch circuit that includes a high-side transistor and receives the input voltage;
a step-up switch circuit that includes a low-side transistor and outputs the output voltage;
a ramp voltage generation circuit that generates a ramp voltage based on a first clock signal;
a middle voltage generation circuit that generates a middle voltage of the ramp voltage based on the ramp voltage generated by the ramp voltage generation circuit;
an error amplifier circuit that generates an error signal based on an error between a feedback voltage of the output voltage and a reference voltage;
an inverting amplifier that inverts the error signal based on the middle voltage generated by the middle voltage generation circuit to generate an inverted signal;
a first comparator that compares the ramp voltage with the error signal to generate a first PWM signal;
a second comparator that compares the ramp voltage with the inverted signal to generate a second PWM signal; and
a logic circuit that generates a control signal for controlling operations of the high-side transistor and the low-side transistor based on the first PWM signal and the second PWM signal.

2. The controller circuit of claim 1, wherein the ramp voltage generation circuit includes a first ramp voltage generator and a second ramp voltage generator that respectively generate ramp voltages,
wherein the second ramp voltage generator is configured to generate the ramp voltage having a same form as the ramp voltage generated by the first ramp voltage generator in synchronization with the first ramp voltage generator, and the middle voltage generation circuit generates the middle voltage of the ramp voltage based on the ramp voltage generated by the first ramp voltage generator,
wherein the first comparator compares the ramp voltage generated by the second ramp voltage generator with the error signal to generate the first PWM signal, and
wherein the second comparator compares the ramp voltage generated by the second ramp voltage generator with the inverted signal to generate the second PWM signal.

3. The controller circuit of claim 2, wherein the first ramp voltage generator and the second ramp voltage generator respectively generate the ramp voltages that are commonly based on the first clock signal,
wherein the middle voltage generation circuit includes a phase adjustment circuit that generates a second clock signal by adjusting a phase of the first clock signal, and a sample/hold circuit that samples and holds the ramp voltage generated by the first ramp voltage generator, and
wherein the phase adjustment circuit generates the second clock signal by adjusting the phase of the first clock signal so that the sample/hold circuit samples and holds the middle voltage of the ramp voltage generated by the first ramp voltage generator based on the second clock signal.

4. The controller circuit of claim 3, wherein the sample/hold circuit includes a switch that operates according to the second clock signal, and a capacitor that samples and holds the ramp voltage generated by the first ramp voltage generator, and
wherein the capacitor is provided to sample the ramp voltage generated by the first ramp voltage generator when the switch is on, and to hold a sampled voltage when the switch is off.

5. The controller circuit of claim 1, wherein the ramp voltage generation circuit changes a peak voltage of the generated ramp voltage according to a change in a frequency of the first clock signal that is input.

6. The controller circuit of claim 1, wherein the ramp voltage generation circuit changes a peak voltage of the ramp voltage according to a change in the input voltage.

7. The controller circuit of claim 1, which is integrated on a single semiconductor chip.

8. A step-up/step-down DC/DC converter, comprising:
the roller circuit of claim 1.

9. A vehicle, comprising:
the up/step-down DC/DC converter of claim 8.
